(19) United States
(12) Patent Application Publication
(10) Pub. No.: US 2011/0174280 A1
(43) Pub. Date: Jul. 21, 2011

(54) OIL SEPARATING DEVICE

(75) Inventors: Jan ZIMMERMANN, Mainz (DE); Ute SCHLEPPY, Ruesselsheim (DE)

(73) Assignee: GM GLOBAL TECHNOLOGY OPERATIONS LLC, Detroit, MI (US)

(21) Appl. No.: 13/009,420

(22) Filed: Jan. 19, 2011

(30) Foreign Application Priority Data
Jan. 19, 2010 (DE) 102010004910.7

(51) Int. Cl. F02B 25/06; B01D 45/16

(52) U.S. Cl. 123/573

(57) ABSTRACT

An oil separating device is provided for crankcase gases of a combustion engine with a separating element. The separating element is at least partially arranged on a cylinder head of the combustion engine.

### CROSS-REFERENCE TO RELATED APPLICATION

This application claims priority to German Patent Application No. 102010004910.7, filed Jan. 19, 2010, which is incorporated herein by reference in its entirety.

### TECHNICAL FIELD

The technical field relates to an oil separating device for crankcase gases of a combustion engine with a separating element.

### BACKGROUND

When operating a combustion engine, and particularly an internal combustion engine, leakage gas flows, so-called blowby gases, develop between piston, piston rings and cylinder running surfaces. This blowby gas, which reaches or is conducted to the crankcase space or into a camshaft housing above the cylinder head, contains liquid constituents, primarily fine oil droplets or low-boiling constituents of the engine oil. As a result of moving power plant components, namely pistons, connecting rods, crankshaft or camshaft, larger oil droplets can also be present in the crankcase gas or in the camshaft housing gas. This is termed surge oil. In order to discharge the blowby gases, a ventilation of the crankcase, which in most cases is routed via the camshaft housing, is provided.

These pulsating gas/fluid quantities that occur and which are termed crankcase gases are freed of the liquid constituents through an oil separating device and then usually directed into the intake region of the combustion engine. Through the oil separation, contaminations in the downstream regions are avoided and the emission of hydrocarbons is not increased in an undesirable manner.

Here it is known that such an oil separating device is provided in a cylinder head cover which is arranged above the cylinder head for closing off the cylinder head. This is known for example from DE 197 00 733 A1, in which an oil separating device for crankcase gases is described. This publication discloses and teaches arranging the components of the oil separating device mentioned at the outset in the cylinder head cover of the combustion engine in an integrated manner. Here, a pre-separating device and a cyclone separating device of the oil separating device are arranged on the inside of the cylinder head cover, which is on the side of the cylinder head cover facing the crankcase or camshaft housing. A fine separating device and a valve device of the oil separating device are arranged between two housing cover halves of the cylinder head cover and in terms of flow, after the cyclone separating device. The arrangement of such an oil separating device in a cylinder head cover however requires a lot of installation space. If the requirements in terms of the oil separating device grow, the installation space required grows as well, while the available installation height however is reduced at the same time because of the greater requirements.

At least one object is to make available an oil separating device for crankcase gases of a combustion engine, with which a reduced installation space requirement with same separating performance and/or increased separating performance with same installation space requirement can be achieved. In addition, other objects, desirable features, and characteristics will become apparent from the subsequent summary and detailed description, and the appended claims, taken in conjunction with the accompanying drawings and this background.

### SUMMARY

The oil separating device for crankcase gases of a combustion engine comprises a separating element, wherein the separating element is at least partially arranged on a cylinder head of the combustion engine. Compared with the prior art, the separating element of the oil separating device is no longer arranged in the cylinder head cover, but at least partially on the cylinder head itself. Because of this, the separating performance of the oil separating device can be increased without the required installation space or the installation size of the combustion engine having to be increased. With same separating performance it is even possible to reduce the installation space requirement or the necessary size of the engine. Furthermore it is possible through the arrangement of the separating element in the cylinder head to reduce the necessary costs for producing such an oil separating device and simultaneously increase the freeze-proof safety of the system because of the higher temperatures prevailing in the cylinder head. Advantageously, the entire separating element or the oil separating device is arranged on the cylinder head or integrated in the cylinder head.

According to an embodiment, the separating element is arranged in a riser line of the cylinder head. In that the separating element is directly arranged in a riser line already provided on the cylinder head, elaborate designs or re-developments of the cylinder head can be avoided. Because of this, both the effort as well as the costs for the production of such an oil separating device can be reduced. In particular, no additional bores have to be provided in the cylinder head because of this.

In addition it is preferably provided that the separating element is releasably fastened to the cylinder head. The separating element in this case is preferentially releasably fastened in the riser line of the cylinder head. Here, the separating element can for example comprise hook elements which can be hooked onto the edge surrounding the riser line. Because of this, a particularly simple assembly of the separating element on the cylinder head or on the riser line of the cylinder head is possible. It is also possible for example to fasten the separating element to the cylinder head or the riser line of the cylinder head or the edge region of the riser line of the cylinder head by means of screws. Through the releasable fastening the separating element for example can also be more easily replaced if required.

In addition, the separating element can preferably be fixed on the cylinder head by means of a cylinder head cover arranged on the cylinder head. Following the positioning of the separating element on the cylinder head or on the riser line of the cylinder head the cylinder head cover can for example be mounted on the cylinder head, where through the mounting of the cylinder head cover or through the placing of the cylinder head cover onto the cylinder head, fixing of the separating element arranged in the cylinder head can be performed at the same time. This can be affected for example in that the separating element by means of the fitted cylinder head cover is clamped between the cylinder head and the cylinder head cover and because of this is held in its position. Because of this, particularly simple fixing of the separating element on the cylinder head without additional resources is possible, where this is particularly advantageous when the separating element is hooked into the riser line by means of hook elements.

Alternatively to this, it is also provided that the separating element is cast into the cylinder head. Because of this, the separating element can be directly mounted in the desired position on the cylinder head during the manufacture of the cylinder head. This allows particularly precise positioning of the separating element in the desired position on the cylinder head. To this end, the separating element can be developed for example from a bent sheet metal part so that the bent sheet metal part can be already incorporated in the cylinder head during the casting of the cylinder head, so that a positive connection of the separating element with the cylinder head can be carried out.

Here, the separating element can preferably be designed unitarily with the cylinder head. Here, the separating element together with the cylinder head is preferentially cast in one piece, wherein the separating element is cast of the same material as the cylinder head. To this end, the separating element or the oil separating device is preferentially already molded into the sand core of the crankcase gas riser line so that the separating element is formed of the same material as the cylinder head or the riser line of the cylinder head. Because of this, the production or the manufacture of a cylinder head with such an oil separating device or with such a separating element can be carried out in one production step, as a result of which the manufacturing time can be reduced. In addition, the position of the separating element on the cylinder head or in the riser line of the cylinder head can be precisely predetermined because of this.

According to a further embodiment, the separating element is designed as deflection device. The crankcase gas that flows through the separating element in this case is preferentially deflected in the separating element, wherein through the deflection a particularly efficient separation of oil particles on the separating element can take place, since through the deflection a rebounding effect can be created.

The separating element designed as deflection device preferentially comprises a first row of one or several turns with a pitch of approximately >5%. The crankcase gas in the process is routed through the separating element via the turns. In that the turns have a pitch of approximately >5%, the turns have a rebounding function, where the oil particles can settle on the inner walls of the turns. Because of this, the crankcase gas by force is subjected to a certain flow direction. The pitch in this case preferentially amounts to between approximately 5% and approximately 90%, particularly preferred between approximately 20% and approximately 70%.

In addition it is preferably provided that the separating element comprises a second row of one or several turns with a pitch of approximately >5%, wherein the first row and the second row are arranged parallel to each other. By providing a second row the separating performance of the separating element can be increased because of the higher throughput.

The direction of the pitch of the turns of the first row in this case is preferentially provided opposite to the direction of the pitch of the turns of the second row. In that the turns of the respective rows have a different pitch direction, the separating performance can be further increased since the flow of the crankcase gases runs in opposite directions in the individual rows.

Alternatively to designing the separating element as deflection device the separating element can also be designed as cyclone separating device. The separating element designed as cyclone separating device can for example comprise a helical flow section, which is formed through a coil with a central opening through which a tubular or cylindrical inner piece is inserted, and which is substantially connected to the coil in a tight manner. The circumferential edges of the coil in this case are formed preferentially sealing against the inside of the circumferential side walls of the riser line. In this manner, through the inner piece, the screw-shaped turns of the coil and of the circumferential walls of the riser line or the separating element, the helical flow section is formed or delimited. As a result of inertia forces, the liquid constituents in the helically flowing crankcase gas can be separated radially outside and because of their gravity flow down the coil section. Here, however, the separating element can also be designed in the form of a function principal other than that of a cyclone separating device.

In addition, a combustion engine is provided comprising an oil separating device designed and further developed as above.

### BRIEF DESCRIPTION OF THE DRAWINGS

The present invention will hereinafter be described in conjunction with the following drawing figures, wherein like numerals denote like elements, and:

FIG. 1 a schematic representation of an oil separating device according to an embodiment of the invention arranged on a cylinder head;

FIG. 2 a schematic representation of a separating element of the oil separating device shown in FIG. 1;

FIG. 3 a schematic representation of an oil separating device on a cylinder head according to a second embodiment of the invention; and

FIG. 4 a schematic representation of a sand core of a crankcase gas riser line with separating element arranged therein.

### DETAILED DESCRIPTION

The following detailed description is merely exemplary in nature and is not intended to limit application and uses. Furthermore, there is no intention to be bound by any theory presented in the preceding background or summary or the following detailed description.

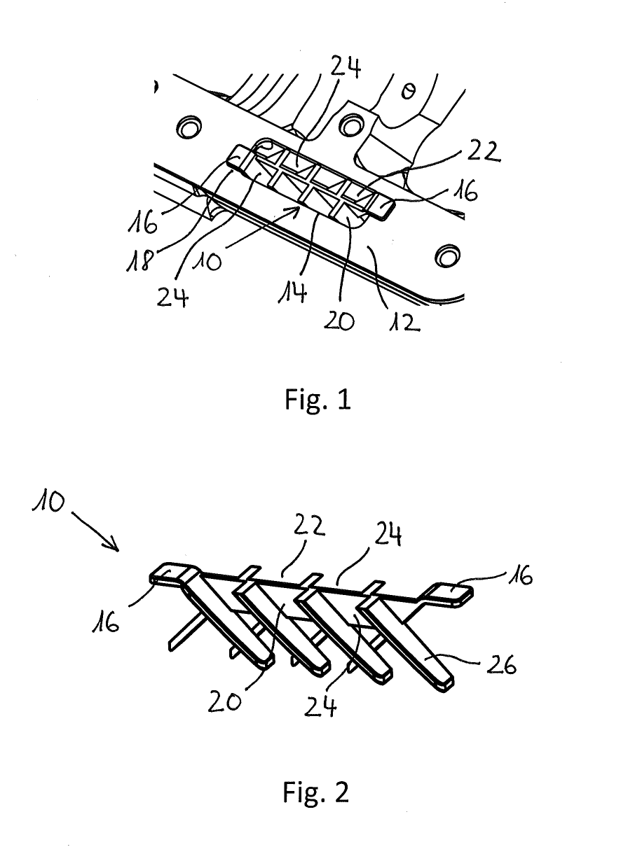

FIG. 1 schematically shows an oil separating device for crankcase gases of a combustion engine according to the invention, where a separating element 10 of the oil separating device is arranged on a cylinder head 12 of the combustion engine. The separating element 10 in this case is arranged in a riser line 14 of the cylinder head 12.

The separating element 10 shown in FIG. 1 is releasably arranged in the riser line 14 of the cylinder head, where in this case the separating element 10 is hooked into the riser line 14. The separating element 10, which in FIG. 2 is once more shown separately, comprises two hook elements 16, which can be hooked into the edge 18 of the riser line 14, in that the hook elements 16 come to lie on the edge 18 of the riser line 14. The separating element 10 itself comprises a first row 20 and a second row 22 each with four turns 24, via which the crankcase gases can flow through the separating element 10. The turns 24 each have a pitch which is approximately >5%, where in this case the direction of the pitch of the turns 24 of the first row 20 is provided opposite to the direction of the pitch of the turns 24 of the second row 22. The turns 24 in this case are formed through web elements 26, which are arranged at an angle to the edge 18 of the riser line 14, so that a pitch of the turns 24 is achieved. With the embodiments shown in FIG. 1 to FIG. 3, the separating element 10 is designed as a deflection device. The separating element 10 can be produced of both a plastic or a metal, where in the case of a metal the separating element 10 can for example be bent of a sheet metal or cast of a metal.

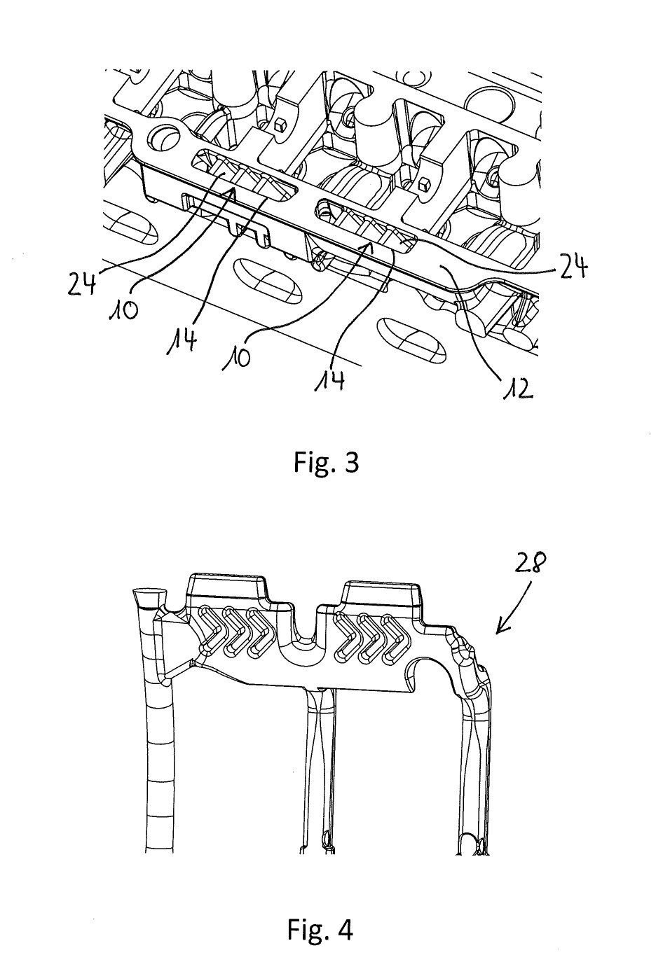

FIG. 3 shows a second embodiment of the oil separating device where in this case the separating element 10 is cast into the cylinder head 12. This can be effected either in that when casting the cylinder head 12 or the riser line 14 of the cylinder head 12 the separating element 10 is also placed in the casting mold and the riser line 14 is cast round about the separating element 10 or it is possible that the separating element 10 is molded into the sand core 28 of the riser line 14 as shown in FIG. 4 or designed so that the separating element 10 can be unitarily cast with the cylinder head 12 or with the riser line 14 of the cylinder head 12. The separating element 10 with the embodiment shown in FIG. 3 is designed in a single row and likewise comprises four turns, where in this case two separating elements 10 are provided on the cylinder head 12 one after the other.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An oil separating device for crankcase gases of a combustion engine, comprising:
a cylinder head of the combustion engine; and
a separating element at least partially arranged on the cylinder head of the combustion engine.

2. The oil separating device according to claim 1, wherein the separating element is arranged in a riser line of the cylinder head.

3. The oil separating device according to claim 1, wherein the separating element is releasably fastened to the cylinder head.

4. The oil separating device according to claim 1, wherein the separating element is fixed on the cylinder head with a cylinder head cover arranged on the cylinder head.

5. The oil separating device according to claim 1, wherein the separating element is cast into the cylinder head.

6. The oil separating device according to claim 5, wherein the separating element is designed unitarily with the cylinder head.

7. The oil separating device according to claim 1, wherein the separating element is designed as deflection device.

8. The oil separating device according to claim 7, wherein the separating element comprises a first row of at least one turn with a pitch of approximately >5%.

9. The oil separating device according to claim 8, wherein the separating element comprises a second row of a turn with a second pitch of approximately >5%, and
wherein the first row is substantially parallel to the second row.

10. The oil separating device according to claim 9, wherein a direction of the pitch of the turn of the first row is opposite to a second direction of the pitch of the turn of the second row.

11. The oil separating device according to claim 1, wherein the separating element is designed as cyclone separating device.
